(19) United States
(12) Patent Application Publication
(10) Pub. No.: US 2016/0150617 A1
(43) Pub. Date: May 26, 2016

(54) LIGHTING DEVICE FOR ADJUSTING A LIGHT COLOUR SEPARATELY WITHIN SEVERLA ZONES

(71) Applicant: KONINKLIJKE PHILIPS N.V., Eindhoven (NL)

(72) Inventor: LOUIS-XAVIER MARIE MONTAGNE, LYON (FR)

(21) Appl. No.: 14/905,191

(22) PCT Filed: Jul. 16, 2014
(86) PCT No.: PCT/EP2014/065198

§ 371 Date: Jan. 14, 2016

(30) Foreign Application Priority Data
Jul. 24, 2013 (EP) 13306069.9

(51) Int. Cl. H05B 33/08; G02B 26/08; G02B 26/10; G01J 3/50; G01J 1/44

(52) U.S. Cl. CPC H05B 33/0869; G01J 3/501; G01J 1/44; G02B 26/101; G02B 26/0833

(57) ABSTRACT

A lighting device (100) is suitable for adjusting a light colour with respect to elements contained within an output field, separately for each element. The lighting device comprises at least two light systems (1a-1d) each adapted for operating as a light detector and also as a light source, a scanning system (2) suitable for scanning the output field, and a processing unit (3). Such lighting device is especially adapted for exhibiting articles with producing enhanced appeal to an observer. To this purpose, light which is directed towards each element may be enhanced in saturation and brightness as compared to initial light reflected by the element, while hue may be substantially maintained.

The invention relates to a lighting device which is capable of varying a light colour between different zones within a lighting field.

### BACKGROUND OF THE INVENTION

There are applications for lighting devices which require directing light with varying spectral features towards separate zones within a total field to be illuminated. Indeed, elements or manufactured articles with different respective colours may be illuminated each with light of suitable colour, for making this article more appealing to an observer. Such requirement exists in particular for lighting devices which are implemented in shop windows, for example clothing windows or food display shelves. For the example of exhibiting a food plate with green vegetables and meat, colours can be enhanced when lighting the vegetables with greenish light and the meat with reddish light. Then, the composite food plate can be made more appealing to a customer. But the effect obtained will be mitigated or even spoilt if light with wrong colour overlaps on a food portion corresponding to another colour. In the above example, appeal for the meat portion in the composite food plate is spoilt if part of the green light impinges on the meat instead of the vegetables.

There are situations where multiple lighting devices with different respective light colours can be implemented. This is so for several clothes arranged in a shop window. Then each lighting device can be oriented towards the desired cloth, depending on the cloth colour. However each light device produces a light beam which does not match the cloth outline as existing in the shop window, so that a customer is aware of the lighting effect. Another drawback is the total cost of the multiple lighting devices which are necessary to suit any content of the shop window and its arrangement in space. Still another drawback is the time necessary for an operator to direct the light beams of all the lighting devices towards the right articles exhibited. But there are also applications in which using multiple lighting devices is not appropriate, because the elements to be illuminated with different colours are close to one another. This is so for example when illuminating a composite food plate from about 30 to 50 centimeters from the plate.

Document U.S. Pat. No. 5,752,766 describes a LED-based device which is suitable for modifying a perceived light colour. The device is provided with an array of LEDs arranged in clusters each comprised of one blue LED, one green LED and one red LED. The LED of each colour can be energized for selective periods of time and/or with different degrees of intensity, so that the perceived light colour can be varied over a wide range, while still obtaining a uniform colour field of light projected in any case.

Document U.S. 2010/0194291 describes an illumination apparatus includes an image sensor, an arithmetic unit, a control unit and a light source unit. The light source unit can irradiate at least red, green, and blue lights. The image sensor photographs an object illuminated by the light source unit. The arithmetic unit calculates color components distributed on the object on the basis of a photographed image. The control unit controls color lights of the light source unit according to the color components distributed on the object calculated by the arithmetic unit.

Starting from this situation, one object of the present invention consists in providing a lighting device which is capable of illuminating simultaneously separate zones within a scene, with beams of different light colours.

A further object of the invention consists for the light beams with different colours to match separately outlines of elements which are contained in the scene, while reducing undesired beam overlaps on neighbouring elements.

Still another object of the invention consists in providing such lighting device which does not require work time from an operator for adjusting the projected light beams with respect to the scene elements.

Still another object consists in providing such lighting device, which is low-cost, easy-to-install, and of reduced dimensions.

### SUMMARY OF THE INVENTION

For meeting at least one of these objects or others, a first aspect of the present invention proposes a lighting device according to claim 1, which is suitable for adjusting a light colour with respect to elements to be illuminated.

Hence, because the invention device is capable of both light detection and light production, with intermediate data processing, it can adjust the beams

with different spectral features to the spatial locations and outlines of several elements which are contained in the illuminated scene. The elements are identified separately from one another before illumination based on respective spectral measurements. Then the illuminating light which is directed onto each element is set as a function of the colour range which corresponds to the spectral measurements. The intermediate use of the colour range for each zone or element allows compatibility with colour modulations that may exist within one and same element, for example due to variations in the orientation of the element surface. Thus, the invention lighting device is capable of illuminating simultaneously separate zones within a scene, with beams of different light colours.

Because the light systems can each operate as light detector and light source in combination with the scanning system, zones which are identified as corresponding to different colour ranges are also illuminated according to different respective target intensities, with zone outlines which are maintained between detection in step /1/ and illumination in step /3/. Hence, the light beams with different colours match the outlines of the elements contained in the scene, with reduced beam overlaps on the neighbouring elements.

Advantageously, the processing unit may be further adapted to control an automatic execution of steps /1/ to /3/. Almost no action is thus necessary from an operator. In case the content of the output field may vary in time, the lighting device may be further adapted for automatically repeating steps /1/ to /3/, so as to update the intensities measured, the outlines of the zones identified within the output field, the colour ranges and the target intensities.

The spectral source feature of one light system can correspond to a first given spectral range, and the spectral source of another light system can correspond to a second given spectral range, different from the first spectral range. For example, the spectral source feature of one first light system can correspond to Red (R) light, the spectral source feature of one second light system can correspond to Green (G) light, and the spectral source feature of one third light system can correspond to the Blue (B) light.

In another exemplary embodiment, the spectral source feature of one first light system can correspond to white light, for example continuous spectrum white, while the spectral source feature of one second light system can correspond to a given colour light.

For improved colours of the light beams which are directed onto separate elements, and increasing the appeal to an observer, the spectral source feature of at least one of the light systems may correspond to white light, or the spectral detection range of at least one of the light systems may correspond to white light, or both may be combined.

For improved colours of the light beams which are directed onto separate elements, and increasing the appeal to an observer, a maximum number of light systems with different wavelengths can be used so as to provide a richer spectral resolution and improve the lighting device performances, or the spectral detection range of the light systems may correspond to a maximum of light systems of different wavelengths.

Alternatively or in combination with such white light one or two other wavelengths can be used.

Alternatively or in combination with such white light spectral feature and/or range, the spectral source features of at least three of the light systems may correspond respectively to blue light, green light and red light, and the respective spectral detection ranges of these three light systems may also correspond to blue light, green light and red light. RGB colour system can then be implemented.

In preferred embodiments of the invention, each light system may be based on a LED which is connected to a power source so as to operate either as light detector or as light source. Such embodiments are low-cost, and provide exact matching between light detection directions which are involved in step /1/ and light production directions involved in step /3/. Thus, the light beams with different colours can match the outlines of the elements contained in the scene even more accurately, with beam overlaps on the neighbouring elements which are more reduced.

In such LED-based embodiments, the processing unit may be adapted also for controlling the LEDs and the scanning system during step /3/. Then, it may be further adapted for implementing intensity time-modulation with at least one of the light systems, simultaneous lighting of different ones of the zones by at least two of the light systems, or a combination of both such time-modulation and simultaneous lighting, when directing light within the zones in accordance with the target intensities. In this way, more efficient lighting can be obtained, together with better colour setting and reduced energy consumption.

Independently or in combination with the preceding advantageous and/or preferred embodiments, the scanning system may comprise a digital mirror device. Such scanning system is reduced in dimensions, commercially available, and its implementation is well-known. Combined implementations using both LEDs and digital mirror devices are even more advantageous, because they allow rapid scanning of the output field with instant light colour possibly modulated at scanning rate. Scanning rate values up to 100 Hz (hertz) or more can be obtained in this way, producing very good visual rendering while minimizing flickering effects.

Also for further improved outline matching, the lighting device may further comprise an optical system which is arranged for coupling optically the output field to each one of the light systems, in a manner identical when this light system operates as light detector compared to the same light system operating as light source. Preferably, the optical system may be adapted for forming an image of the elements which are contained in the output field, focussed onto an active surface of the digital mirror device. Put another way, the optical system is set for focussing received light onto the digital mirror device in step /1/, and such focussing conditions are maintained in step /3/.

For some applications of the invention lighting device, the processing unit may be further adapted for determining the target intensities in step /2/ so that a mean colour saturation value for at least one of the elements as illuminated during step /3/, is higher than a mean colour saturation value derived from the intensities measured in step /1/ for the same element. Alternatively or in combination, the target intensities may be determined in step /2/ so that a mean hue value for at least one of the elements as illuminated during step /3/ is equal to a mean hue value derived from the intensities measured in step /1/ for the same element.

These and other features of the invention will be now described with reference to the appended figures, which relate to preferred but not-limiting embodiments of the invention.

### BRIEF DESCRIPTION OF THE DRAWINGS

FIG. 1 illustrates an application for which a lighting device according to the invention is especially appropriate;

FIG. 2 represents an exemplifying embodiment of the invention; and

FIG. 3 represents a practical embodiment of the invention.

For clarity sake, element sizes which appear in these figures do not correspond to actual dimensions or dimension ratios. Also, same reference numbers which are indicated in different ones of these figures denote identical elements of elements with identical function.

### DETAILED DESCRIPTION OF THE INVENTION

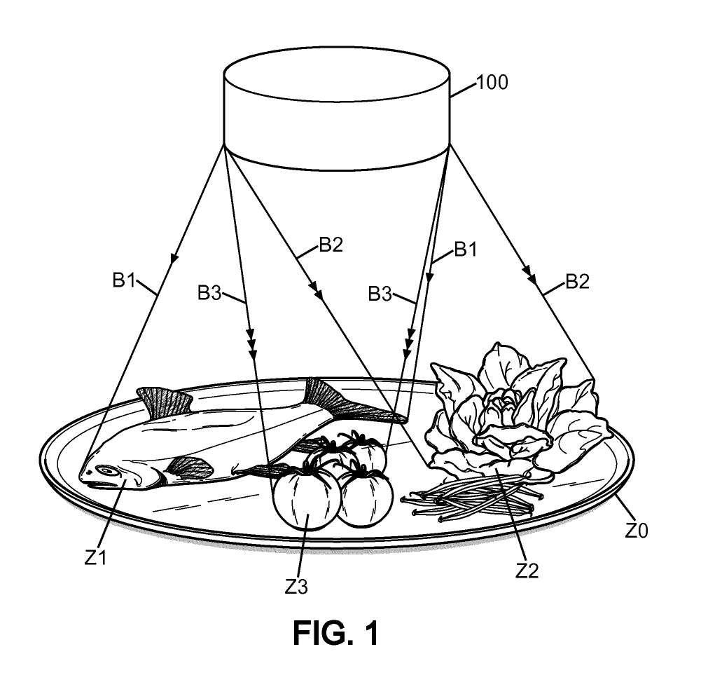

In FIG. 1, reference label Z0 denotes a composite food plate which contains several food elements of different colours: a fish portion Z1, green vegetables Z2 and tomatoes Z3. Such plate is to be exhibited in a restaurant presentation, for example. It is to be illuminated using the lighting device 100 which is arranged above the plate Z0, at about 40 cm from this latter. For appealing to the restaurant customers, the fish portion Z1 is to be illuminated with a white or bluish light beam denoted B1 and marked with single arrows, the vegetables are to be illuminated with a greenish light beam denoted B2 and marked with duplicated arrows, and the tomatoes with a reddish light beam B3 with triplicate arrows. But such appeal-enhancing effect would be spoilt if the greenish light beam B2 or the reddish light beam B3 also impinges onto the fish portion Z1, possibly giving to the customers the disastrous impression that the fish portion is somewhat rotten. Therefore, the beams B1 to B3 should be quite accurately limited to the corresponding food element, without going much beyond the peripheral outline of this element. In addition, these requirements should be maintained even if the plate is pushed or rotated. Obviously, similar conditions apply for other food elements, but with the light colours being adapted to the types of the food elements so as to be appealing to the customers in all cases.

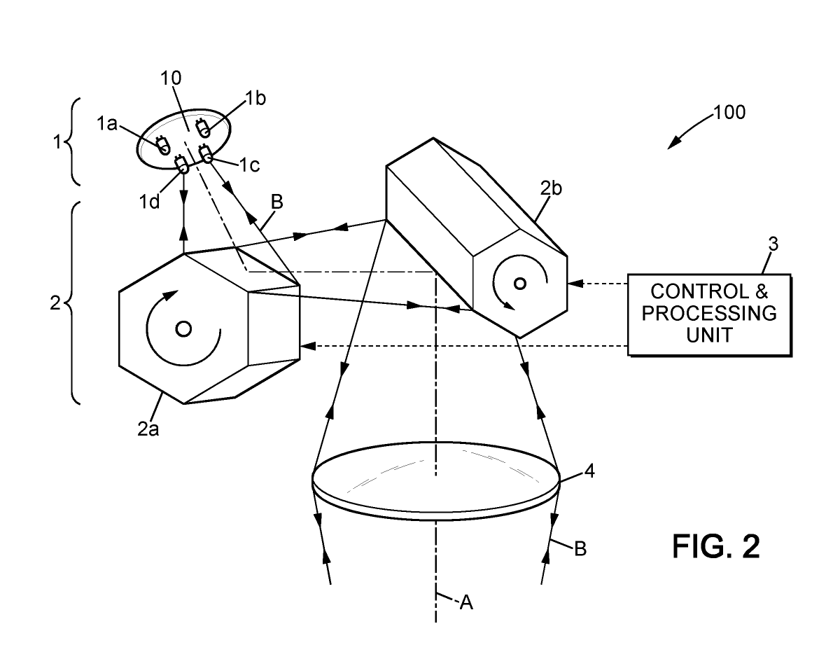

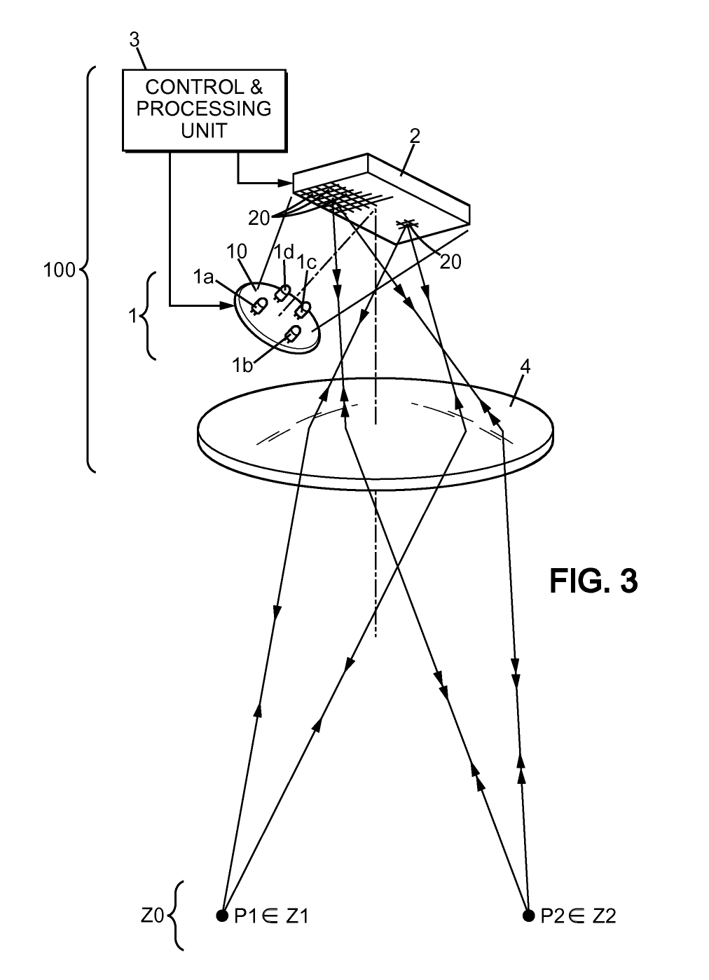

In FIGS. 2 and 3, the following reference numbers denote the components now indicated of the lighting device 100:
1a to 1d four light systems forming all together a light set denoted 1 as a whole
2 a scanning system, which is two-dimensional for most of the applications of the invention, but may be one-dimensional also
3 a processing unit, possibly including an integrated circuit and preferably having additionally a control function over the operations of the light systems 1a to 1d and the scanning system 2
4 an optical system, which may be of imaging type, for example a positive lens

In preferred invention embodiments which are now described, each one of the light systems 1a to 1d is comprised of a LED controlled and electrically connected so that it can operate either as a light detector or as a light source. It shall be observed that in other embodiments, a light system may comprise a light emitting unit and a detecting unit, the light emitting unit and detecting unit having substantially aligned optical axes, i.e. having respective optical images sufficiently close to each other so that they can be considered as co-localized by an observer. As this is of common knowledge, any LED operating as a light detector is efficient for detecting light limitedly within a spectral detection range, which may be expressed in term of wavelength. Also, any LED operating as a light source upon being energized electrically produces light according to a defined spectral source feature. Actually, both the spectral detection range and the spectral source feature are determined by the semiconducting materials which form the active part of the LED. Detection range and source feature are related to each other in this way, but they may be different. In addition, for improving the colour impression to an observer of the illuminated plate Z0, it is preferred that one of the LEDs is efficient over the whole wavelength range of light visible to human eye. Hence, for exemplifying purpose, the LED labelled 1a is supposed to be a white LED, the LED labelled 1b is supposed to be a blue LED, and those labelled 1c and 1d respectively a green LED and a red LED. Each LED is connected appropriately to a suitable power source (not shown), and such connection may be switched between two connection modes corresponding respectively to the detection operation and the source operation of the LED. For example, the polarity of the LED connection to the power source is inverted between both modes. For the lighting device 100 to be compact and easier-to-assembly, the four LEDs 1a to 1d may be mounted onto a common support 10.

In the embodiment of FIG. 2, the scanning system 2 comprises two rotating drums 2a and 2b, each with mirrors arranged on the drum periphery parallel to the rotation axis. The drums 2a and 2b are driven into rotation by motors (not shown), preferably steppers, at controlled speeds about respective rotation axes which are perpendicular to each other. In this manner, a light beam B which is produced globally by the light set 1 is directed by the scanning system 2 though the optical system 4, parallel to the direction A within the output field of the lighting device 100. Operation of the scanning system 2 moves the direction A throughout the whole output field, along a two-dimensional scanning track. Due to reverse paths of light rays being identical, an external light which enters into the lighting device 100 along the direction A within the beam shape B, is directed onto the light systems 1a to 1d and detected by these latter when controlled to operate as light detectors. This external light can then be analyzed according to the LED spectral detection ranges, and operation of the scanning system 2 allows that such analysis of the external light can be performed for all scan positions of the direction A throughout the output field.

In the embodiment of FIG. 3, the scanning system 2 comprises a set of micromirrors 20 which are arranged according to a two-dimensional matrix, and which can each be controlled individually in orientation. Such micromirror matrix is well-known, commercially available and commonly called digital micromirror device. For example, each micromirror 20 may be square with 20 μm (micrometer) in size, and the matrix may be 800×600 or more. For this embodiment, the optical system 4 is preferably adapted for forming an image of the elements which are contained in the output filed of the lighting device 100, onto the surface of the digital micromirror device comprised of all micromirrors 20. For example, points denoted P1 and P2 pertain to the composite food plate Z0, with P1 being located on the fish portion Z1 and P2 on the green vegetables Z2. Possibly the optical system 4 may be adjusted in focal length so that a sharp image of the scene elements can be obtained at the surface of the digital micromirror device whatever the distance of the lighting device 100 from these scene elements. However, the invention does not require that the image of the scene which is formed at the surface of the digital micromirror device is very sharp, and a rough image with defocus blur may be sufficient.

Also preferably, the light set 1 may be reduced in size, with the LEDs 1a to 1d close to each other. All the light systems are arranged appropriately for each one being capable of illuminating at a same time the whole surface of the digital micromirror device.

The digital micromirror device and the light set 1 are arranged in space so that each one of the micromirrors 20 reflects light from the light set 1 towards the output field through the optical system 4 for a first orientation of the micromirror 20, and out of a pupil of the optical system 4 for a second orientation of the micromirror 20 different from the first orientation. For example, the second orientation of the micromirror 20 may direct the light as produced by the light set 1 towards a suitable light sink (not shown).

When the LEDs 1a to 1d of the light set 1 are operating as detectors, each micromirror 20 when in the first orientation directs the external light which originates from the point in the scene conjugated with this mirror, towards the LEDs 1a to 1d for detection and spectral analysis. The light which originates from the scene and enters into the lighting device 100 is generally light reflected scattered by the scene elements but it may be also be light produced by light sources, if such sources contribute to the lighting of the output field. The whole scene is scanned by controlling all the micromirrors 20 in turn, one at a time, into the first orientation while the other micromirrors are controlled in a third orientation towards a light sink arranged suitably for the external light. This forms an acquisition step, or detection step, which is a first step in a use sequence of the light device 100. This detection step may be controlled by the processing unit 3, for performing the micromirror scanning and the recording of the light intensities measured by each one of the LEDs 1a to 1d for each one of the micromirrors 20 being successively in the first orientation.

In preferred embodiments, it may also not be resorted to a light sink and a second or third orientation of the micromirror 20, the control and processing unit 1 being then configured in such a way that no light is emitted from the light set 1 or detected by the light set 1 during appropriate time periods.

Then a processing step, or analysis step, is performed by the processing unit 3. During this processing step, the previously measured intensities are analyzed, for identifying zones within the output field, for example the composite food plate, which correspond to different colour ranges. Using colour ranges allows that areas with slightly varying colour pertain to a same one of the identified zones. The colour ranges may be selected from a lookup table stored, or determined from an analysis of the measured intensities. Suitable algorithms are well known in the art to this purpose.

Such processing step results in a list of colour ranges with zones contained in the output field where the measured intensities correspond to a colour that is contained in one of the colour ranges. Referring to the scene example represented in FIG. 1, a first colour range corresponds to neutral hue, from grey to white colour, and is associated with the zone in the output field which is occupied by the fish portion Z1. A second colour range corresponds to green hue, whatever the saturation and brightness values, and is associated with the zone in the output field which is occupied by the vegetables Z2. And a third colour range corresponds to red hue, again whatever the saturation and brightness, and is associated with the output field zone of the tomatoes Z3.

Then, the processing unit 3 determines target light intensities to be produced by each one of the LEDs 1a to 1d operating as light sources, for each one of the zones identified. These target intensities are based on the respective colour ranges of the zones. In most of applications, the saturation and the brightness of a mean colour within each colour range are to be enhanced, while maintaining substantially the hue value. RGB coordinates may be used for deriving the colour ranges and the corresponding mean colour from the intensities measured. Then increased values for saturation and brightness are selected while maintaining hue value almost constant, and these values may be converted back to RGB coordinates for determining the target intensities to be produced for each zone by each one of the LEDs 1a to 1d. For better colour rendering, the currently described sequence is implemented using the RGB colour coordinates but further completed with a white colour component. It shall be noticed here, as mentioned above, that a better visual rendering can be obtained by possibly adding other wavelengths.

The third and last step of the use sequence is the lighting step. During this last step, all LEDs 1a to 1d are controlled for operating as light sources, and for producing light according to the target intensities which have been determined previously, and according to the respective light source features of the LEDs, and with synchronization with a scan executed by the scanning system 2. In this manner, each zone identified within the output field is illuminated using a light colour which is appropriate with respect to the food element that is contained in this zone. The micromirror scan needs to be rapid enough for not being perceived by the observer. Typically, the scan rate may be higher than 100 Hz (hertz).

For improving the output light intensity in particular, the processing unit 3 may determine the target intensities to be directed towards all zones using time-modulation for instant light intensities to be produced, and also time-share for the time-periods dedicated to illumination of at least two of the zones. Time-modulation consists in varying in time the instant light intensity which is produced by at least one of the LEDs 1a to 1d when a same one of the micromirrors 20 is maintained in the first orientation, for reflecting the LED-produced light towards the output field zone. When this time-modulation is rapid enough, it cannot be perceived by the observer of the illuminated scene. Time-share consists in having two or more micromirrors 20 which are controlled to be simultaneously in the first orientation. The corresponding points in the scene are thus illuminated simultaneously with the same instant light colour, but the finally-resulting light colours may be further modified in a manner which is different for these scene points by implementing additional lighting time periods for these points, also possibly with different time-modulation. Such time-modulation and time-sharing may be combined during the processing step by the processing unit 3, and implemented accordingly during the lightning step. Hence, the target intensities as initially determined by the processing unit 3 correspond to time-averaged values for the instant light intensities which are actually directed to the scene over a complete scan performed during the lighting step. In particular, time-sharing is efficient for reducing the amount of light produced which is wasted during the lightning step.

Some aspects of the above-described lighting devices and operations may be adapted while retaining at least some of the advantages cited. For example, further additional LEDs may be used, possibly of amber colour or any other additional colour. Also each light system may have a structure different from a LED. It may be comprised for example of a beam splitter or a partially-reflecting plate combined with a light detector which is located on one side of the plate, and a separate light source located on the other side of the plate. A colour filter may also be dedicated to each light system. Light systems with different structures may be combined within the light set of one same lighting device according to the invention.

1. Lighting device suitable for adjusting a light colour with respect to elements to be illuminated, said lighting device comprising:
at least two, LED based light systems, each having a respective light detecting unit configured for detecting light limitedly within a respective spectral detection range and a light emitting unit for operating either as a light detector capable of measuring a light intensity corresponding to a respective spectral detection range effective for said light system or as a light source capable of producing light in accordance with a respective spectral source feature effective for said light system;
a scanning system, suitable for scanning an output field of the lighting device and comprising a digital mirror device;
an optical system arranged for coupling, optically the output field to each one of the light systems, in a manner identical when said light system operates as light detector compared to said light system operating as light source, the optical system being adapted for forming an image of the elements contained in the output field focussed onto an active surface of the digital mirror device, and
a processing unit, adapted to control execution, by the light systems and the scanning system, of the following steps successively:
a detection step, where each light system operating as light detector, together with the scanning system, collects a distribution of measured intensities over the output field, for external light originating from the elements contained in the output field, the intensities measured by each light system corresponding to a part of the external light which pertains to the spectral detection range effective for said light system;
a processing step, where the processing unit identifies zones within the output field based on the distributions of measured intensities collected in the detecting step, so that at least two of said zones are associated with separate respective colour ranges, and the processing unit assigns to each one of the colour ranges at least two target intensities to be produced respectively by the light systems in accordance with the spectral source features; and
a lighting step, where the light systems are operating as light sources, and controlled each for producing light according to the target intensities, and the scanning system is controlled simultaneously so that light which is produced in accordance with the target intensities assigned in the processing step to one of the colour ranges, is directed limitedly within the zone which is associated to said colour range, and the target intensities being different for at least two of the zones.

2. Lighting device according to claim 1, wherein the processing unit is further adapted to control an automatic execution of detecting, processing and lighting steps.

3. Lighting device according to claim 2, adapted for automatically repeating detecting, processing and lighting steps, so as to update the intensities measured, outlines of the zones identified within the output field, the colour ranges and the target intensities.

4. Lighting device according to claim 1, wherein the spectral source feature of at least one of the light systems corresponds to white light.

5. Lighting device according to claim 4, wherein the spectral detection range of at least one of the light systems corresponds to white light.

6. Lighting device according to claim 1, wherein the spectral source features of at least three of the light systems correspond respectively to blue light, green light and red light, and the respective spectral detection ranges of said three light systems correspond to blue light, green light and red light.

7. Lighting device according to claim 1, wherein each light system is based on a LED connected to a power source so that said LED operates either as light detector or as light source.

8. Lighting device according to claim 7, wherein the processing unit is adapted for controlling the LEDs and the scanning system during lighting step, and for implementing intensity time-modulation with at least one of the light systems, simultaneous lighting of different ones of the zones by at least two of the light systems, or a combination of both said time-modulation and simultaneous lighting, when directing light within the zones in accordance with the target intensities.

9-10. (canceled)

11. Lighting device according to claim 1, wherein the processing unit is further adapted for determining the target intensities in processing step so that a mean colour saturation value for at least one of the elements as illuminated during lighting step is higher than a mean colour saturation value derived from the intensities measured in detecting step for said element.

12. Lighting device according to claim 11, wherein the processing unit is further adapted for determining the target intensities in processing step so that a mean hue value for at least one of the elements as illuminated during step /3/ is equal to a mean hue value derived from the intensities measured lighting step for said element.
